(19) United States
(12) Patent Application Publication
(10) Pub. No.: US 2025/0045818 A1
(43) Pub. Date: Feb. 6, 2025

(54) SYSTEMS AND METHODS FOR RAPID TRAVERSAL OF A DYNAMIC SEARCH TREE

(71) Applicant: Anmarth, LLC, St. Louis, MO (US)

(72) Inventors: Patrick J. Dolan, St. Louis, MO (US); Michael J. Gallagher, Des Peres, MO (US); John P. Gallagher, St. Louis, MO (US); Thomas M. Gallagher, St. Louis, MO (US)

(21) Appl. No.: 18/793,019

(22) Filed: Aug. 2, 2024

Related U.S. Application Data
(60) Provisional application No. 63/530,656, filed on Aug. 3, 2023.

(51) Int. Cl. G06Q 30/08; G06Q 20/20; G06Q 20/34; G06Q 20/40; G06Q 40/03

(52) U.S. Cl. CPC G06Q 30/08; G06Q 20/20; G06Q 20/34; G06Q 20/40; G06Q 40/03

(57) ABSTRACT

Systems and methods for rapid traversal of a dynamic search tree to conduct a competitive auction for a transaction at the point of sale and at the speed associated with conventional payment card transactions, typically in credit transactions.

### CROSS-REFERENCE TO RELATED APPLICATIONS

This application claims the benefit of U.S. Prov. Pat. App. Ser. No. 63/530,656, filed Aug. 3, 2023, the entire disclosure of which is incorporated herein by reference.

### BACKGROUND OF THE INVENTION

### Field of the Invention

This disclosure is related to the field of transactional computing, and more particularly to systems and methods for integrating the use of AI models in making point decisions about computerized transactions based on node-specific participation criteria.

### Description of the Related Art

To understand the present disclosure, it may be helpful to understand the commercial embodiment in which the systems and methods were conceived, though the systems and methods described herein are by no means limited to this particular commercial embodiment. The systems and methods described herein pertain to, among other things, credit card processing, cash advancements, buy now pay later (BNPL), and payment card processing.

When a payment card holder (a “cardholder”) begins a payment card transaction, he or she presents the payment card to a merchant as a payment method, either physically (e.g., in person at the point of sale), constructively (e.g., over a telephone conference), or virtually (e.g., e-commerce web sites). The merchant collects certain transaction details, such as the transaction amount, card number, expiration date, and Card Verification Value (“CVV”), and the merchant securely transmits these details, along with any other relevant information about the transaction, to the merchant's payment processing service or acquiring bank. The acquiring bank is usually the bank holding the merchant's commercial accounts.

Payment cards are usually issued by an issuer, often a bank (known as an issuing bank) or another private enterprise. Issuers will be collectively referred to herein as the “issuer” for simplicity. The acquiring bank or payment processor (which will be collectively referred to herein as the “payment processor” for simplicity) thus acts as an intermediary between the merchant and the issuer. The payment processor contacts the issuer through the payment network to confirm the charge. The issuer receives the authorization request and performs various checks and validations. The issuing institution next verifies the cardholder's account details, credit limit, check whether any fraud or security alerts are associated with the card, confirm the information provided at the point-of-sale matches cardholder data, and ultimately issue a decision whether to approve or decline the transaction. Upon receiving the response from the issuer, the payment processor conveys the authorization to the merchant, which can then proceed with the sale to the cardholder.

After the transaction is completed, the merchant submits a batch of authorized transactions to the payment processor or acquiring bank for settlement. The payment processor or acquiring bank then transfers the funds from the cardholder's account to the merchant's account, typically within a few business days. The merchant may incur a fee for each transaction, which is determined by their agreement with the payment processor or acquiring bank.

The cardholder then receives a credit card statement from the issuer showing the authorized transactions during the prior billing cycle. The cardholder then pays off the balance that month, or, for a credit transaction, may make monthly installment payments, with the unpaid balance usually accumulating finance charges. This credit financing typically carries an interest rate agreed upon contractually in advance when the cardholder applied for the credit card. While the rate itself may be variable depending on market factors, it does not vary from transaction to transaction; that is, all authorized credit transactions carry interest at the same rate (whatever the rate is).

One of the problems with payment cards is a lack of competition. Consumer credit is generally issued based on a combination of market conditions and individual consumer creditworthiness, but as noted above, credit cards generally carry a single interest rate irrespective of the nature of the underlying transaction. But each individual transaction has unique risk characteristics, and the appropriate market rate for the transaction may be higher or lower than the pre-agreed upon rate between the cardholder and issuer. While the market may dictate an issuing bank to unilaterally increase existing credit card interest rates for its consumers holding said cards, the individual consumer risk characteristics do not flexibly change, regardless of consumer risk profile changes. For example, if the cardholder inherits a substantial sum of money, which would significantly decrease the cardholder's borrowing risk, the cardholder's current interest rates remain unchanged. However, there is no way in the current technical architecture of payment systems to introduce competitive bidding. Issuers instead compete for cardholders on other criteria, such as rewards and points programs, and overall interest rate, and sales and marketing efforts. But, since market factors and consumer creditworthiness (a relatively static data point used strictly during credit application underwriting) tend to be the dominant factors, this amounts to little competition and little meaningful choice for the cardholder. Additionally, credit reporting agencies may punish consumers for frequent credit inquiries and multiple cards, which can worsen the interest rates available to the consumer.

What is needed in the art is the technical ability to introduce competitive bidding for consumer credit transactions at the point-of-sale and which operate seamlessly within the existing technical framework of payment card networks without requiring that existing protocols and technical systems be altered or changed to accommodate the additional information that is required for point-of-sale credit competition to occur. Further, and paradoxically, the transaction-specific information required for competing creditors to bid on a transaction must be examined, and a winning bidder selected, within the effectively real-time operational deadlines that merchants and consumers alike have become accustomed to over the last few decades.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is A method for real-time competitive credit card transaction auctions at the point-of-sale comprising: providing a competitive credit auction bidding payment network; issuing, to a user, a payment card having routing information encoded thereon for processing, via the competitive credit auction bidding payment network, point-of-sale transactions using the payment card; during a point-of-sale transaction at a merchant: reading the routing information from the payment card; transmitting a transaction authorization request to the competitive credit auction bidding payment network, the authorization request comprising transaction characteristics for the transaction, the transaction characteristics including an account number of the payment card, a transaction amount of the transaction, a transaction type of the transaction, and a merchant identification number of the merchant; receiving, at the competitive credit auction bidding payment network, the transmitted authorization request; the competitive credit auction bidding payment network processing the received authorization request via a competitive bidding module, the competitive bidding module automatically determining a winning bidder lender to issue credit for the transaction from among a plurality of candidate lenders, each of the candidate lenders being preregistered to participate in the competitive credit auction bidding payment network, the determining comprising: for each candidate lender, determining a rate at which the each candidate lender is willing to extend credit in the transaction amount for the transaction by traversing an N-ary decision tree for the each candidate lender comprising a plurality of nodes encoding data about the conditions under which the each candidate lender is willing to extend credit and a credit rate associated with each of the conditions, and comparing each traversed node with one or more of the transaction characteristics and/or profile data about the user accessible to the competitive bidding module to determine a rate matching the conditions; sorting the determined rates to identify a lowest rate among the determined rates; and selecting as the winning bidder the each candidate lender associated with the lowest rate; and responding to the authorization request with an indication that the transaction is accepted.

### BRIEF DESCRIPTION OF THE DRAWINGS

FIG. 1 depicts a schematic view of an embodiment of a real-time competitive credit card auction system and method for rapid traversal of a dynamic search tree according to the present disclosure.

FIG. 2 depicts a flow diagram of an embodiment of a method for implementing a dynamic search tree according to the present disclosure.

FIG. 3 depicts an embodiment of a dynamic search tree according to the present disclosure.

FIG. 4 depicts an embodiment of an auction module with data inputs and outputs according to the present disclosure.

FIG. 5 depicts an embodiment of an alternative dynamic search tree according to the present disclosure.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Because of the current state of the art, described herein, among other things, are systems and methods for rapid traversal of a dynamic search tree, using additional consumer data to conduct a competitive auction for a transaction at point of sale, at the speed associated, today, with the art. While these systems and methods are described herein in the context of the commercial embodiment of competitive bidding for credit at the point-of-sale, the systems and methods described herein are suitable for use in any technological environment in which it is desirable to introduce competitive bidding or other opportunities for participation in a computer system by a plurality of independent third-party systems, each with its own priorities and criteria for participation, while allowing decision-making in real-time, using existing technical frameworks.

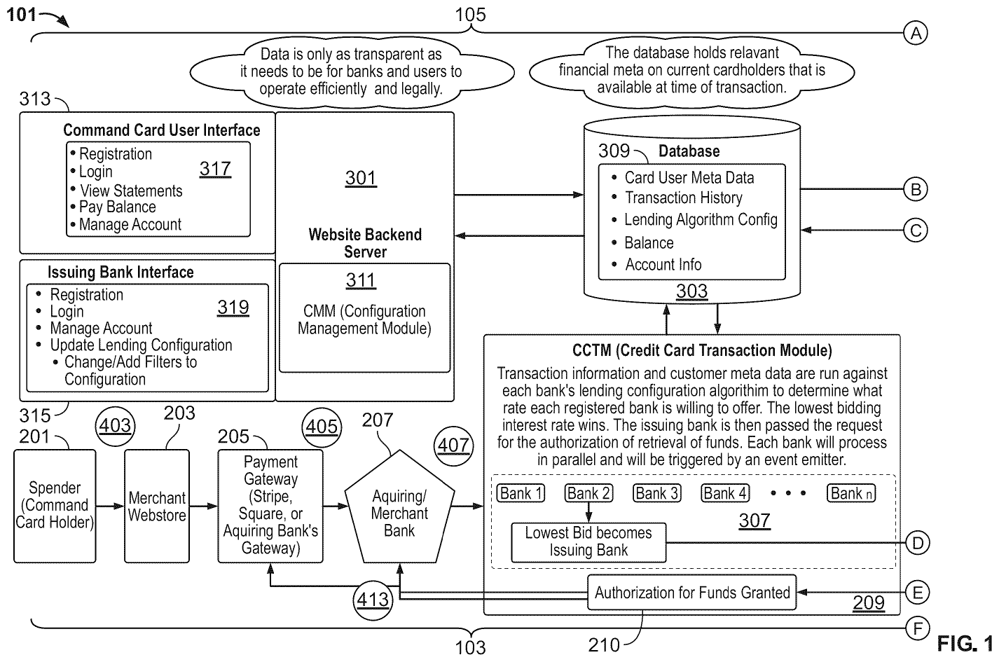

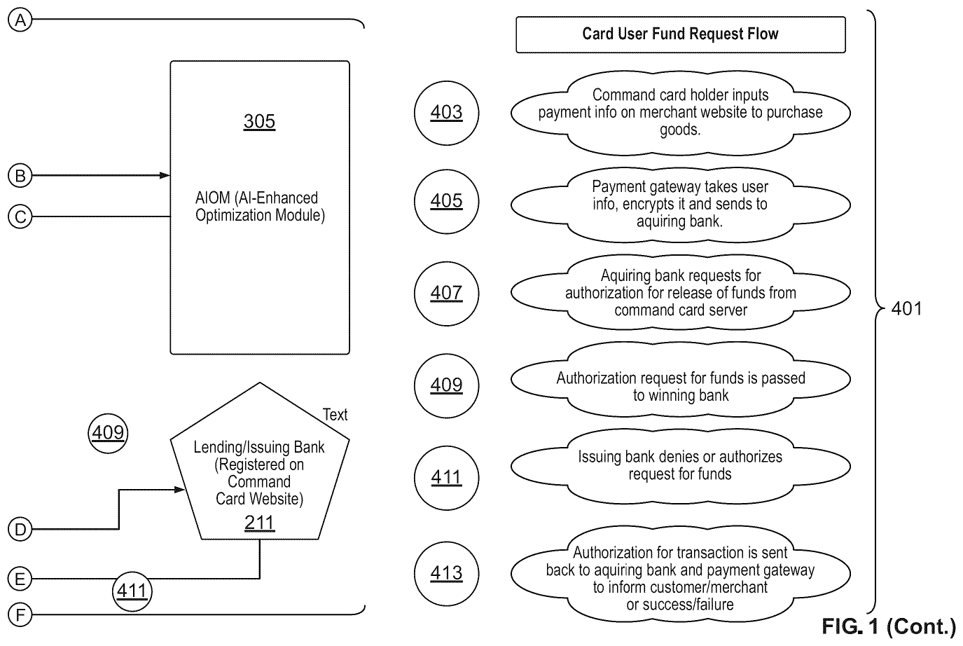

FIG. 1 depicts an embodiment (101) of a real-time competitive credit card auction systems and methods for rapid traversal of a dynamic search tree. The depicted embodiment of FIG. 1 shows a conventional credit card payment processing system (103) modified to include the present systems and methods, as described elsewhere herein. A special type of payment card is issued to a consumer. The payment card is configured for use in a competitive credit bidding auction payment network as described herein. This may be done by encoding in the magnetic stripe (or inlaid computer chip or other encoding technology) of the card payment networking routing information which causes the transactions using the payment card to be processed using a competitive auction credit bidding payment network as described herein. Such a payment card will be referred to herein as CCAB (competitive credit auction bidding) card. The consumer to whom the card is issued may alternatively be referred to as a cardholder, spender, or borrower.

In the depicted embodiment, a backend server (301) hosts a website, including a configuration management module (311) and one or more user interfaces (313) and (315) for the auction-based payment network. The users are either card holders with the payment network or lending institutions who are registered participants with configurable lending rates for the card holders. These interfaces (313) and (315) are used by card holders to, for instance, check their balance, or used by lending institutions to, for instance, configure their lending rate logic for prospective customers (i.e., the decision trees described elsewhere herein). These interfaces (313) and (315) use the backend server (301) to route API to a database (303).

In the depicted embodiment, the consumer (201) presents the CCAB card to a merchant (203) for a payment transaction to acquire goods or services or otherwise seek to transact a payment. The merchant (203) swipes the card or otherwise collects and processes the CCAB card information in the conventional manner to attempt to authorize the payment transaction, such as by use of a payment processing or gateway (205), such as Stripe, Square, or the merchant's acquiring bank (207). Again, these services are collectively referred to herein as “payment processors.”

The payment processor (207) then submits the transaction in the conventional manner to the payment network. Examples of such payment networks include Visa™, MasterCard™, and American Express™. The payment network, and how to initiate the transaction, is typically a function of the encoded payment network details on the payment card. For example, cards transacting using the Visa network usually begin with the number 4, whereas MasterCard is 5 and American Express numbers begin with 3. The next five digits identify the issuer, and the final set of digits identifies the cardholder's account number. Using the present systems and methods, a transaction may be submitted using an existing payment network, but with the issuer identified as an enterprise implementing the CCAB payment network described herein. Alternatively, a new payment network may be identified.

In the prior art, at this point, the transaction information would be passed on to the issuer (211) to confirm the transaction and approve or decline it. However, in the present systems and methods, the payment network instead submits the transaction information for automatic decision by a plurality of issuers and/or lenders. This automatic decision by a plurality of issuers and/or lenders is done via the payment network, which appears to the payment processor (e.g., an acquiring bank) (207) to be a conventional issuer but is not. Instead, a credit card transaction module (CCTM) server (209) receives the authorization request and sends/passes the associated transaction data to competitive bidding or auction module (307) programmed with the logic to implement competitive credit bidding as described herein. In the depicted embodiment, the CCTM server (209) hosts the competitive bidding module (307), but alternative architectures are possible (such as where a different physical or logical server hosts the competitive bidding module (307) and/or provides functionally equivalent services).

The depicted embodiment, the CCTM server (209) receives from the payment processing entities (205) and (207) the transaction data, which includes information for a conventional credit card transaction, such as the account number, transaction amount, type of transaction (e.g., purchase, refund, void, pre-authorization, etc.), and a merchant identification number or code. The CCTM server (209) may then provide this information to a competitive bidding module (307) which will algorithmically identify the best available lender for that specific transaction. This determination is made based on a combination of the transaction characteristics received from the payment processor, cardholder-specific data accessible to the CCTM server (209) and lender-specific criteria structurally encoded into a decision tree (e.g., multi-leaf, N-ary, or other) that may be rapidly traversed as described herein to identify a most competitive or most preferred bid. This and other information may be stored in a database (303) communicatively and/or operatively coupled with the CCTM server (209).

The available lenders are generally determined based on which lenders have enrolled to participate in the competitive bidding process. Typically, this involves the lender signing up to participate, usually via a web form or another method for automated or semi-automated enrollment known in the art and providing information about the characteristics of transactions and borrowers the lender is interested in bidding on, and at what rates or under what terms the lender will issue credit.

The competitive bidding process described herein is preferably carried out in real-time, or near real-time, and, in any event, within commercially accepted operational timeframes for a point-of-sale payment card transaction. Typically, this means the system must be able to respond to a transaction request within 5-10 seconds under typical operating conditions, though occasional longer delays are generally expected. As such, the CCTM server (209) is preferably able to receive and process the transaction data, and select a winning bidder, within that amount of time.

It will be clear to a person of ordinary skill in the art that this operational timeframe could never be met if each potential lender were to be consulted about each transaction, assess the transaction data, and decide on an interest rate to offer. Instead, an automatic decision-making system must be used to encode and represent each lender's preferences and criteria, and this decision-making system, such as an N-ary decision tree, must analyze this preference and criteria information for all lenders, as compared to the proposed transaction, in only a few seconds. However, lenders may have wildly disparate forms and types of criteria. It is thus helpful to organize and structure these disparate criteria into a single format which can be quickly and programmatically traversed to determine whether the lender is willing to extend credit for the particular transaction, with a particular risk profile, and at what interest rate.

To ensure sufficient processing time to meet the operational deadlines expected in a real-time or near real-time payment card transaction processing system, lender preferences and criteria may be encoded into a set of criteria nodes organized into a decision tree structure (e.g., N-ary) in which each node represents a filter criterion and has two or more child nodes. The child nodes are either another criteria node, or a decision node. The decision node may be to decline to extend credit, or to extend credit (i.e., bid on the transaction) at a particular interest rate. This structure provides a number of key advantages in terms of data encoding and traversal speed, including that the node criteria are flexible and can be adapted to meet the unique needs of any lender, the nested structure also provides flexibility in tree design for more rapid traversal (as discussed elsewhere herein), and the decision tree structure, means if a lender adds an additional criteria, only a single additional decision point is added to the tree. Although the worst-case complexity for an N-ary tree is O(n), the tree structure may be balanced and optimized, either directly by the lender, an administrator, or with the assistance of an AI model. If the N-ary tree is balanced properly, this will cause the worst-case complexity for search is achieve O(log n).

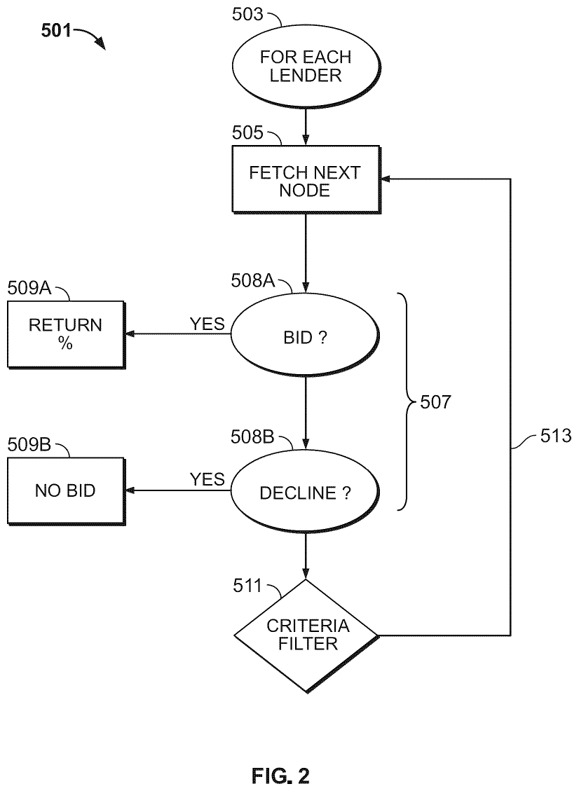

A non-limiting, exemplary embodiment of this process is shown in FIG. 2. In the depicted embodiment of FIG. 2, a method (501) for implementing the N-ary decision tree is shown. The depicted method (501) is carried out for each lender (503) participating in the bidding process. For each such lender, the auction module begins by fetching the next node (505) in the N-ary decision tree for that lender. When the module first begins, this “next” node will be a first, or root node conceptually situated at the “top” of the lender's N-ary decision tree. This starting point may be determined by the lender, an administrator, or using an AI model to optimize the tree structure to maintain the most rapid possible traversal, as described elsewhere herein.

Each node is either a criteria node or a decision node. A decision node is either a decision to bid at a given interest rate, or a decision to pass on the transaction. Thus, when the next node (505) is identified, the module first determines whether it is a criteria or decision node (507). This logic is shown programmatically in FIG. 2 as two separate operations but depending on how the logic is implemented in program instructions, they may be combined into a single operation. In the depicted embodiment of FIG. 2, the module first determines whether to bid (508A) and, if so, the traversal is concluded and the lender's percentage rate for the transaction is returned as its bid (509A). If the node does not indicate a bid, the module then determines whether to decline or pass on the auction (508B). If so, traversal is concluded and the lender's decision to offer no credit is returned as its bid (509B), effectively meaning it will not bid at all.

If neither of these conditions applies (e.g., the node in question is not a decision node), then the node is a filter or criteria node which encodes decisions and preferences about lender bidding rules (511). The lenders' bidding rules (511) may be stored in a database (303) when the bank registers to participate in the rate bidding process. As described elsewhere herein, this information is collected from the lender in advance and encoded in the N-ary search tree for that lender, either by the lender itself, an administrator, or an AI model, as described elsewhere herein. The node may encode any criteria that a computer program is capable of assessing, and it is anticipated that the most common criteria will include the credit score of the borrower (e.g., FICO) and the amount of the transaction.

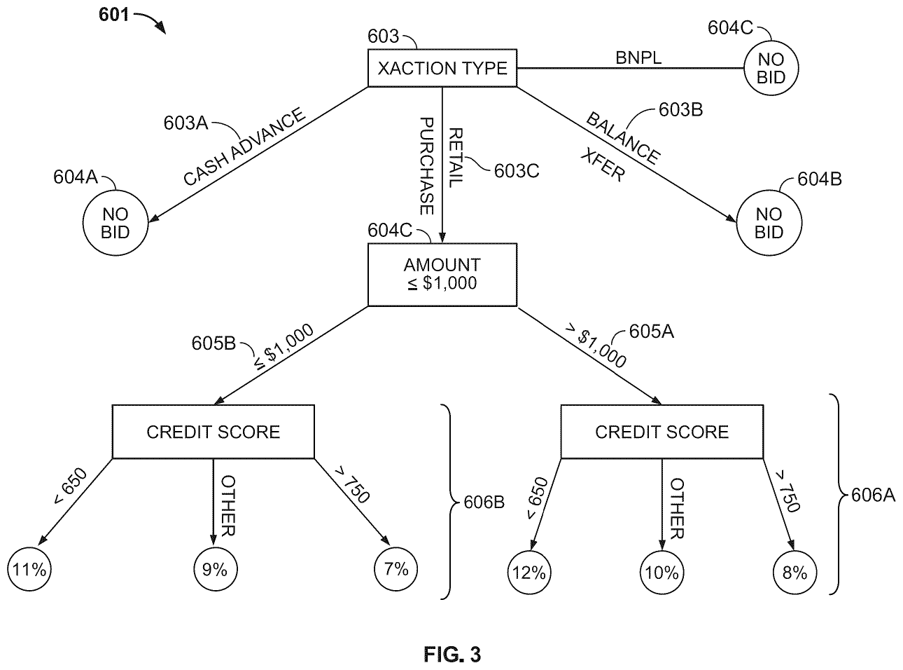

For example, FIG. 3 provides a diagram of an exemplary, non-limiting N-ary decision tree. In the depicted embodiment, the lender has decided that it will extend credit only for retail purchases (among many other types of purchases/transactions), and it offers two sets of rates depending on whether the transaction is above or below a $1,000 threshold, and then offers rates based on the borrower's credit score, with different rates being offered for scores below 650, between 650 and 750, and above 750. In an embodiment, these and other variables are identified to participating lending institutions as configuration options that may be manipulated and structured in each individual lending institution's decision tree.

Thus, applying this exemplary tree (601) to the embodiment (501) of FIG. 2, the next (and at this stage, first) node selected (505) is the depicted transaction type node (603), which has four child nodes. The criteria filter examines the transaction type and, if it is “cash advance” (603A), the next node (505) is selected, which is to decline to bid (604A). If the transaction type is “balance transfer” (603B), then the next node (505) selected is again to decline to bid (604B). If the transaction type is “buy now pay later” (BNPL), then the next node (505) selected is again to decline to bid. In an alternative embodiment, to reduce data storage, the child node for both criteria (603A) and (603B) may be the same node, since the resulting decision is the same. For these two criteria, the child node(s) are decision nodes.

If the transaction type is “retail purchase” (603C), then the next node (505) selected is another criteria node (604C). The criteria filter thus applies this criterion to a different data element, in this case, the purchase amount for the immediate transaction. As seen in FIG. 3, this node (604C) has two child nodes depending on whether the transaction amount is greater than $1,000. From here, the two remaining branches of the N-ary decision tree (601) are nearly identical in structure, differing only in the leaves—that is, in the interest rates associated with the decision nodes. In the exemplar embodiment shown in FIG. 3, if the amount is >$1,000 (605A) a set of rates (606A) is offered depending on the credit score, with borrowers have a score of <650 receiving a bid of 12%, >750 receiving a bid of 8%, and the default/other (i.e., those falling between those values, inclusive) receiving a bid of 10%. However, if the amount is ≤$1,000 (605B), a second set of rates (606B) is considered depending on the credit score, with borrowers having a score of <650 receiving a bid of 11%, >750 receiving a bid of 7%, and the default/other (i.e., those falling between those values, inclusive) receiving a bid of 9%. Once the module proceeds to node (604C), the tree provides that a bid will be made, and the node structure and traversal process is, in effect, a search of the N-ary decision tree for the matching data.

After a decision breakpoint has been identified for each lender, the bids of all lenders who decided to offer credit (submit a bid/interest rate) are sorted, and the lowest interest rate is selected as the winning bid. That lender then wins the auction and issues the credit and becomes the effective issuing bank. All of this takes place in the matter of a few seconds, such that the transaction appears seamless to the consumer. If no winning bidder is found, the system may include a default lender which will win in the absence of a competitive winning bidder, likely at an elevated interest rate. Alternatively, some bids may be so unattractive that no reasonable institution would issue credit, and the transaction may be declined. It should be noted that an “unattractive” bid in the prior art would involve only a single issuer, the present systems and methods provide the opportunity for numerous competing lenders to consider the transaction, and it is more likely that least one of them will find the transaction sufficiently attractive to offer credit. Conversely, where the transaction is very attractive, competition for it will drive down the winning rate, to the benefit of the consumer. In either case, the consumer benefits by widening the available competing credit lending institutions.

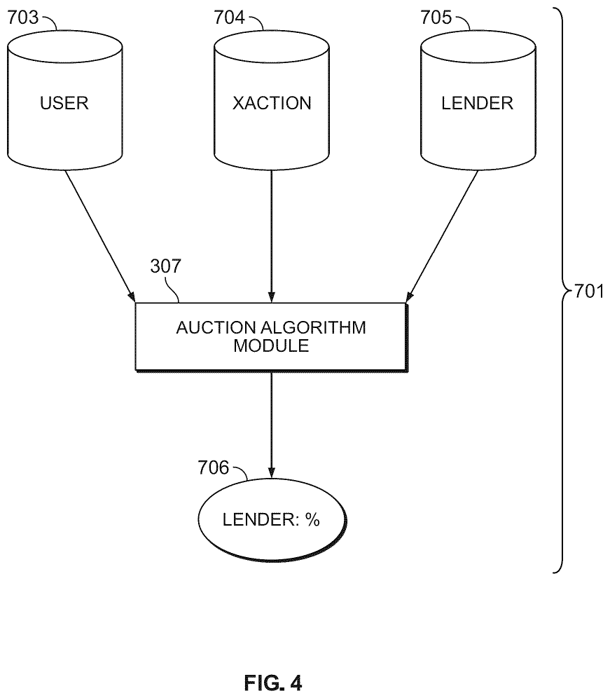

Conceptually, as reflected in FIG. 4, the auction module (307) receives primarily three sources of data and analyzes them to arrive at a single output (a given lender's bid, if any, on a credit transaction). The three main inputs to the module are a collection of user data (703) about the borrower, a collection of transaction data (704) about the particular transaction, and a collection of lender data (705) about the lender. The user data (703) and lender data (705) will generally be supplied to the computer server in advance, and the transaction data (704) is provided at the point of sale. This information is used, as described elsewhere herein, by the auction module (307) to determine a lender's best rate in order to submit a bid (706).

The user data (703) is acquired when a borrower enrolls for access to a payment card that uses the systems and methods described herein for credit. At the time, common information about the borrower is collected, such as name, address, social security number, employment status, home ownership status, employer, annual income, and so forth. This information is commonly collected by credit card issuers. Additional information may also be collected, or may be acquired and developed over time, as described elsewhere herein. Likewise, lender data (705) is acquired when a lender enrolls for the opportunity to bid on credit using the systems and methods described herein, and includes the information needed to populate the N-ary decision tree for the lender. At that time, common or necessary information about the lender is collected. The transaction information (704) is provided as described elsewhere herein, in accordance with the normal operation of the computer systems that operate automated payment card transaction networks. This differs from the prior art in that, currently, neither the credit card issuer nor the lending institution use dynamically collected data to enhance their capability to bid competitively for a user transaction.

The user data (703) and lender data (705) are stored in a database associated with the computer server and may comprise additional data not available in a conventional payment card transaction. This data may comprise a wide variety of information, mainly (but not necessarily only) about the consumer/user's risk profile, which can be used by the lenders to make better, more precise, more informed decisions about issuing credit. This data may comprise behavioral analytics that can be used to determine whether a given transaction presents an unusually high or low risk, such as relative to other transactions for the same borrower or similar borrowers. Likewise, this data may be used to identify higher risks of default, or of fraudulent transactions. In an embodiment, lenders may choose to use such data as part of the lender's N-ary decision tree.

By way of example and not limitation, suppose a given borrower has held relatively stable amounts of income, available credit, and total debt for a significant period, and makes consistent credit payments. However, the borrower then begins to open additional credit, and increase total debt, without any corresponding increase in income. This may indicate a potentially higher credit risk for that borrower before this risk is reflected in credit scores. Whereas in a conventional credit arrangement, the lender has no ability to vary the contractual interest rate on that borrower's credit, using the systems and methods described herein, the system may provide an elevated risk flag or status, or the lender may set particular breakpoints in the decision tree, to identify the issue and offer increased interest rates that capitalize the increased risk of extending future credit. Again, the information used to make these decisions is not otherwise available to the lender in real-time and, even if it was, the lender could not alter the rate on a conventional credit account based on it.

Similarly, AI models can be trained on transaction data to predict and/or classify borrowers who may be approaching a default, or to otherwise identify trends in the transaction data indicating an increased risk associated with a borrower. By way of example and not limitation, suppose a given borrower has held relatively stable amounts of income, available credit, and total debt for a significant period, and makes consistent credit payments. However, the borrower then begins to open additional credit, and increase total debt, without any corresponding increase in income. This may indicate a potentially higher credit risk for that borrower before this risk is reflected in credit scores. Whereas in a conventional credit arrangement, the lender has no ability to vary the contractual interest rate on that borrower's credit, using the systems and methods described herein, the system may provide an elevated risk flag or status, or the lender may set particular breakpoints in the decision tree, to identify the issue and offer increased (or decreased, to compete with the other competitively bidding lending institutions) interest rates. Again, the information used to make these decisions is not otherwise available to the lender in real-time and, even if it was, the lender could not alter the rate on a conventional credit account based on it.

An aspect of the systems and methods described herein is the use of artificial intelligence models to optimize the system. As noted herein, a key performance criterion is effectively real-time decision-making. As the number of lenders, and the complexity of their decision-making, increases, the system could begin to exhibit commercially unacceptable latency. To ensure that this does not happen, an AI model could be trained to examine lender N-ary decision trees and re-organize and optimize them to maximize processing speed. While there are some known methods for optimizing N-ary trees, such as balancing, these approaches are generally agnostic as to the practical environment in which they are used and rely instead on pure data science and theory. That is, balanced trees rely on the mathematical fact that if the longest branches are within 1 node length of each other, the search time complexity is O(log n). While this is a favorable performance profile, it does not necessarily mean that, relative to real-world operational conditions, the tree is optimized.

For example, suppose 90% of all transactions follow a single branch in the tree. If so, the tree might be capable of being reorganized so that the processing time for those transactions is shorter and requires fewer comparisons. This optimization would likely be at the expense of the other 10% of searches, which would take longer than they otherwise would. However, because this optimization would improve performance for 90% of the transactions, the tradeoff is worthwhile, and the system performance and thus user experience for most transactions will improve. A purely mathematical optimization approach cannot make this type of optimization because it is agnostic of real-world operating conditions. Instead, the systems and methods herein may rely on the use of trained AI data models to examine and identify actionable trends in transaction data and tree searches for a given lender and recommend, or automatically perform, reorganizations of the lender's N-ary decision tree to implement optimizations that will reduce search time and increase overall performance based on actual, real-world data. This type of analysis may be performed on a periodic or on-going basis as data patterns change over time based on user behavior and changes to lender criteria.

Similarly, the use of AI models may be applied to assist lenders in establishing trees in the first instance. Instead of providing specific criteria, the lender may instead provide a set of data about the general types of transactions and borrowers the lender is interested in, and the lender's desired rate of return. The AI models can then examine prior transaction data, which is comprised mainly of transaction data involving other lenders, to identify tree configurations likely to meet the lender's goals. Because the borrowers can be asked to provide additional details, more information about borrower characteristics may be available, and this information could be used to advantage the lender in very specific types of transactions.

By way of example and not limitation, suppose a lender wishes to alter its brand and image and appeal more to younger borrowers. However, such borrowers are often higher risk. The lender may have knowledge or insight about unusual demographic characteristics of those borrowers that reduce actual lending risk. For example, the lender may have conducted empirical research indicating that borrowers between the ages of 20-29 who have at least two years of college education and are also retail investors have much lower risk profiles. This type of information is not available even via credit reports, but it can be collected from borrowers who enroll on the platform. The lending institutions can thus leverage this knowledge to offer preferentially lower rates to borrowers who meet this criterion, allowing them to win those lending opportunities.

The amount of type of borrower data that can be collected, whether directly from borrowers, from third-parties, public resources, or inferred characteristics from behavior, is significant, and the insights and relationships that can be extracted or inferred from that data may be highly correlated with credit risk. In a now-famous retail anecdote, as far back as 2012, the Target™ chain of retail stores had data analytics advanced enough to be able to determine with 80% accuracy when a female customer was likely pregnant, even if she had never purchased any maternity products, based on purchasing patterns for non-maternity products. Similar principles can be applied using AI models to examine lending behavior and consumer profile data to find hidden information about consumers that can enable borrowers to make better, more targeted, more competitive lending decisions without undertaking disproportionate risk. Examples of consumer data that could be used to this effect include job or work history, family, or domestic structure (e.g., living with parents or having a roommate to share expenses), hobbies and interests, location (e.g., state, city, ZIP code, neighborhood, school district), home improvements, pets, and so forth. Borrowers may be incentivized to voluntarily provide information about themselves because the information may make them more attractive lending targets, resulting in lower, more competitive interest rates offered in the bid process.

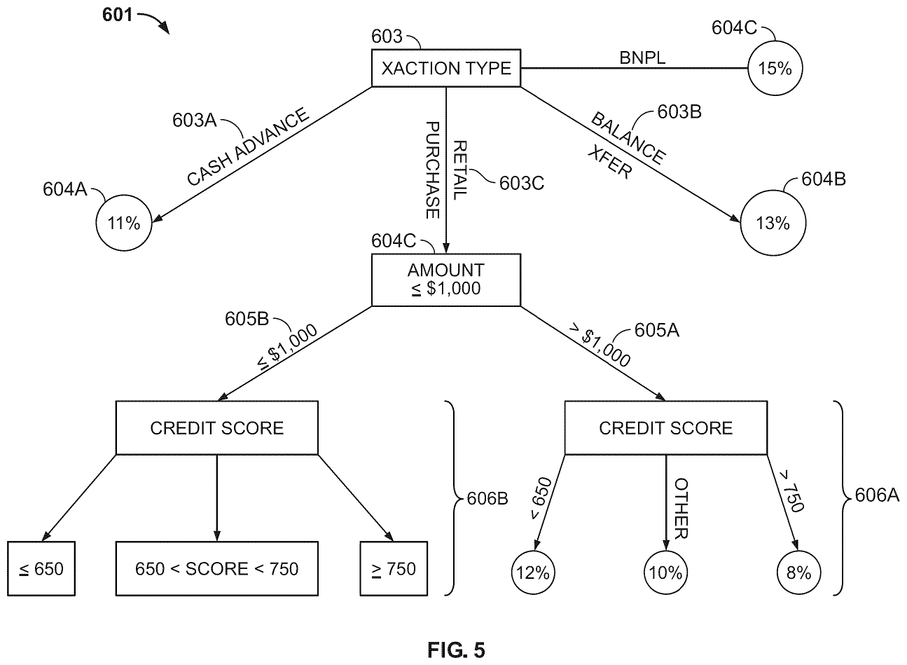

It should be understood that the decision tree in FIG. 3 is an illustrative example of just one possible decision tree, and should be understood as an exemplary, non-limiting example of how one credit issuer might choose to structure and organize its decision tree. The exact composition of any given decision tree, including, but not limited to, the branching criteria, decisions of when to bid or decline to bid, and what rates to offer, will naturally vary not only from embodiment to embodiment, but from lending to lender, based (among other things) on the individual preferences and policies of each lender. By way of example, and not limitation, FIG. 5 depicts an alternative decision tree in which a lender bids on cash advances, balance transfers, and buy now pay later (BNPL) transactions. It should be further noted that, in some embodiments, the “bid” may not be merely a rate, but rather may include other or alternative criteria, such as a repayment term (e.g., a number of months) and/or minimum monthly payment amount.

Throughout this disclosure, relative qualifiers such as “generally,” “about,” and “approximately” may be used. One of ordinary skill in the art will understand that, in the context of this disclosure, these terms are used to describe a recognizable attempt to conform an element or component to the qualified term. Additionally, the use of the conjunctive and disjunctive should not necessarily be construed as limiting, and the conjunctive may include the disjunctive, and vice versa.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device equipped with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, cloud-based virtual machines, compute, storage and any other hardware capable of interacting with the systems and methods described herein in the matter of a conventional “computer.”

As will be appreciated by one skilled in the art, some aspects of the present disclosure may be embodied as a system, method or process, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be used. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Program code embodied on a computer readable medium may be transmitted using any appropriate medium, including but not limited to wireless, wireline, optical fiber cable, RF, etc., or any suitable combination of the foregoing.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the term “cloud” and “cloud computing” and similar terms refers to the practice of using a network of remote servers hosted and accessed over the Internet to store, manage, and process data, rather than local servers or personal computers.

Throughout this disclosure, the terms “web,” “web site,” “web server,” “web client,” and “web browser” refer generally to computers programmed to communicate over a network using the Hypertext Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “real time” refers to software operating within operational deadlines for a given event to commence or complete, or for a given module, software, or system to respond, and generally invokes the response or performance time, in ordinary user acceptable perception and considering the technological context, is effectively, generally, contemporaneous with a reference event. Those of ordinary skill in the art understand “real time” does not literally mean the system processes input and/or responds instantaneously, but rather the system processes and/or responds rapidly enough the processing or response time is within the general human perception of the passage of real time in the operational context of the program. Those of ordinary skill in the art understand, where the operational context is a graphical user interface, “real time” normally implies a response time of no more than one second of actual time, with milliseconds or microseconds being preferable. However, those of ordinary skill in the art also understand, under other operational contexts, a system operating in “real time” may exhibit delays longer than one second, particularly where network operations are involved.

Throughout this disclosure, the term “GUI” generally refers to a graphical user interface for a computing device. The design, arrangement, components, and functions of a graphical user interface will necessarily vary from device to device depending on, among other things, screen resolution, processing power, operating system, device function or purpose, and evolving standards and tools for user interface design. One of ordinary skill in the art will understand that graphical user interfaces generally include a number of widgets, or graphical control elements, which are generally graphical components displayed or presented to the user and which are manipulable by the user through an input device to provide user input, and which may also display or present to the user information, data, or output.

For purposes of this disclosure, there will also be significant discussion of a special type of computer referred to as a “mobile communication device” or simply “mobile device”. A mobile communication device may be, but is not limited to, a smart phone, tablet PC, e-reader, satellite navigation system (“SatNav”), fitness device (e.g., a Fitbit™ or Jawbone™) or any other type of mobile computer whether of general or specific purpose functionality. Generally speaking, a mobile communication device is network-enabled and communicates with a server system providing services over a telecommunication or other infrastructure network. A mobile communication device is essentially a mobile computer, but one which is commonly not associated with any particular location. A mobile communication device is also commonly carried on a user's person, and usually is in near-constant real-time communication with a network.

The terms “artificial intelligence” and “AI” refer broadly to a discipline in computer science concerning the creation of software that performs (or appears to perform) tasks using the reasoning faculties of humans. In practice, AIs currently lack the ability to exercise true human reasoning and are instead trained to simulate reasoning. This effect is contextual, and in most cases, narrowly confined to one, or a very small number, of well-defined tasks (such as recognizing a human face in an image). A common implementation of AI is supervised machine learning, where a model is trained by providing large sets of pre-classified inputs, each set representing different desired outputs from the AI. For example, if the AI is meant to recognize a human face, one set of inputs contains a human face in each image, and one set does not. The “AI” is a statistical engine that uses mathematics to identify and model data patterns common to one set but not the other. This process is known as “training” the AI. Once the AI is trained, new unclassified data is provided to it for analysis, and the software assesses which of the labels it has been trained on best fits the new data. Most AIs also provide a confidence level in the prediction. A human supervisor may provide feedback to the AI as to whether it was right, and this feedback may be used to refine its models further. Each discrete task that an AI is trained to perform may be referred to herein as a “model.” General-purpose AIs not trained on one specific task, notably large language models like ChatGPT, are trained in fundamentally the same way, using enormous data sets covering a broad range of topics, and such models produce output by, essentially, generatively predicting, based on the training data, what the next word in the response can reasonably be predicted in the sequence.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A method for real-time competitive credit card transaction auctions at the point-of-sale comprising:
providing a competitive credit auction bidding payment network;
issuing, to a user, a payment card having routing information encoded thereon for processing, via said competitive credit auction bidding payment network, point-of-sale transactions using said payment card;
during a point-of-sale transaction at a merchant:
reading said routing information from said payment card;
transmitting a transaction authorization request to said competitive credit auction bidding payment network, said authorization request comprising transaction characteristics for said transaction, said transaction characteristics including an account number of said payment card, a transaction amount of said transaction, a transaction type of said transaction, and a merchant identification number of said merchant;
receiving, at said competitive credit auction bidding payment network, said transmitted authorization request;
said competitive credit auction bidding payment network processing said received authorization request via a competitive bidding module, said competitive bidding module automatically determining a winning bidder lender to issue credit for said transaction from among a plurality of candidate lenders, each of said candidate lenders being preregistered to participate in said competitive credit auction bidding payment network, said determining comprising:
for each candidate lender, determining a rate at which said each candidate lender is willing to extend credit in said transaction amount for said transaction by traversing an N-ary decision tree for said each candidate lender comprising a plurality of nodes encoding data about conditions under which said each candidate lender is willing to extend credit and a credit rate associated with each of said conditions, and comparing each traversed node with one or more of said transaction characteristics and/or profile data about said user accessible to said competitive bidding module to determine a rate matching said conditions;
sorting said determined rates to identify a lowest rate among said determined rates; and
selecting as said winning bidder said each candidate lender associated with said lowest rate; and
responding to said authorization request with an indication that said transaction is accepted.
